(19) United States
(12) Patent Application Publication
(10) Pub. No.: US 2026/0234873 A1
(43) Pub. Date: Aug. 13, 2026

(54) PAPER SUPPORTS FOR CONFECTIONERY PRODUCTS AND METHOD FO PREPARATION THEREOF

(71) Applicant: Perfetti Van Melle S.P.A., Lainate (Milano) (IT)

(72) Inventors: Paolo De Regibus, Milano (IT); Alessandro Bottini, Lainate (Milano) (IT); Alice Vailati, Caronno Pertusella (VA) (IT); Luis Bordera, Sant Esteve de Sesrovires (Barcelona) (ES); Ana Porta, Castelldefels (Barcelona) (ES); Lukasz Idaszak, Dabrowka k. Poznania (PL)

(73) Assignee: Perfetti Van Melle S.P.A., Lainate (Milano) (IT)

(21) Appl. No.: 19/150,579

(22) PCT Filed: Jan. 26, 2024
(86) PCT No.: PCT/IB2024/050746

§ 371 Date: Jul. 24, 2025

(30) Foreign Application Priority Data
Jul. 27, 2023 (IT) 102023000001338

(51) Int. Cl. D21H 19/10; A23G 3/56; B31D 5/00

(52) U.S. Cl. CPC D21H 19/10; A23G 3/563; B31D 5/0091

(57) ABSTRACT

A description is given of sticks or supports in paper for confectionery products, in particular lollipops, characterised by optimal properties of adhesion to the edible portion associated with high compatibility with high-speed production lines. Also described is a process for the preparation of said sticks or supports in paper that comprises a heat treatment stage before or after a stage of application of a lubricating substance.

The invention relates to paper supports in the form of a cane or stick, a method for preparation thereof and use thereof in the production of lollipops.

### STATE OF THE ART

Sticks made of paper material are known, as for example illustrated in U.S. Pat. No. 2,218,525, which describes a method of making sticks or canes from rolled paper (or similar material) suitable for confectionery products and having the desired degree of flexibility and resistance to breakage.

The paper material of which the stick described in U.S. Pat. No. 2,218,525 is composed guarantees the best anchorage of the edible portion by virtue of the porosity of the paper, but such porosity may create greater friction during the manufacturing process, making some steps of continuous processing slower.

It is common practice to use lubricating substances to be distributed on the surface of such sticks to allow for better machinability in order to speed up the process of producing the sticks themselves and possible production of products related thereto.

Processes such as the one described in US20220314570 are known where, in addition to the method for producing paper sticks designed for different uses, possible treatments are generically mentioned which, in combination with the other process stages, are suitable for solving the technical problem of speeding up large-scale production while maintaining the possibilities of diversifying the end product according to its intended use.

Although the possible use of this process for the production of sticks intended for lollipops is mentioned, the problem of the possible detachment of the edible portion when the anchorage of the same is assessed at a stage immediately following the formation of the product and in which the edible mass is not yet cooled is not addressed in any way.

In cases wherein the stick does not guarantee an appropriate hot anchorage, measured by appropriate dynamometric methods, the product is deemed not to conform with the expected quality standards and is therefore rejected.

Moreover, it has been noted how the application of certain lubricating substances on the surface of the stick, which are widely used to increase the processability/machinability of sticks, creates lower adhesion of the edible mass to the stick compared to an untreated paper stick.

There is therefore the need to make available paper sticks capable of ensuring optimal adhesion to the edible portion coupled with compatibility with high speed production lines normally used for the production of lollipops and related products.

### DESCRIPTION OF THE INVENTION

The identified solution consists of the making of paper and resin sticks which, while coated with a wax as lubricating substance, have an external surface characterised by a predetermined roughness and/or by a predetermined surface tension.

A first subject of the invention is therefore constituted by paper and resin sticks on which at least one wax is applied as lubricating substance, characterised by a roughness >4.1 μm, preferably between 4.3 μm and 5 μm, measured by confocal microscopy techniques with chromatic aberration, or characterised by contact angle measured by the dynamic Wilhelmy method between 60° and 82°, and having a moisture content no higher than 6%.

The roughness value is expressed as standard deviation of the surface height and is determined by confocal microscopy techniques with chromatic aberration, using for example an FRT MicroProf® instrument.

More particularly, values on the average scale between 0.0624 and 2 mm are considered. Conventional roughness values for paper are comprised between 3.8 and 4.1 μm.

A second subject of the invention is constituted by a process for the preparation of said sticks that comprises the application of a wax as a lubricating substance on the pre-formed paper and resin sticks and a drying treatment, not necessarily in that order, at temperatures higher than 40° C. for times comprised between 1 minute and 72 hours, preferably at temperatures comprised between 7° and 150° C., up to a moisture content no higher than 6% by weight of the stick. In particular, moisture contents of between 3.5% and 5.5% by weight of the total of the stick are preferred.

The surface of the stick, in addition to its roughness as defined, can also be characterised by its surface tension, measured using the contact angle technique.

Surface tension is considered to be a measurement of the surface polarity of the sticks, influenced by the ratio between lubricating substance (apolar) and cellulose (polar) when they are exposed on the surface. Hence, the contact angle is a measure of the surface tension of the stick, but also indirectly of the outcome of the heat treatment described previously, which allows the lubricating substance to penetrate the cellulose matrix, exposing the fibres thereof more, and thus increasing polarity and wettability, with a consequent decrease in the contact angle. The increase in polarity favours interaction with the polar sugars of the edible part, increasing adhesion, which is also described by the detachment force, which can be measured according to methods stated below.

More particularly, the sticks of the invention are characterised by a contact angle, measured according to the dynamic Wilhelmy method, at the first immersion between 60° and 82°, preferably between 67° and 79°, and/or by a contact angle at the second immersion <20°, preferably <10°. Sticks made according to the prior art are characterised by greater contact angles at the first immersion.

The contact angle is measured according to the dynamic Wilhelmy method by immersion in distilled or deionised water such as Milli-Q®, using known instruments such as, for example, the Kruss K100SF or Tensiio tensiometer, or the Sigma 700/701 Attension® tensiometer, or the DataPhysics DCAT 15. At the same time, the water absorption can be measured by measuring the difference in weight of the stick after and before immersion. The sticks of the invention are characterised by water absorption after the second immersion >0.040 g, preferably >0.045 g per stick. Alternatively, the sticks of the invention are characterised by water absorption after the second immersion >10.7% by weight, preferably >12% by weight.

It has therefore been found that the amount of surface wax, the residual moisture content in the sticks, the hot detachment force of the stick at the edible part as described below, the contact angle and the water absorption are correlated one with the other. The sticks with the drying treatment described above have less wax on the surface, less moisture, smaller contact angle, greater water absorption and higher hot detachment force at the edible part when compared with the sticks made according to the prior art (Example 9).

A further subject of the invention relates to the use of sticks having the above-described features and obtained by said process, in a process of preparation of lollipops in which the sticks are immersed in the molten mass which constitutes the edible portion of the confectionery product.

The paper that can be used according to the invention is of any type suitable for use in the food industry. Papers with a basis weight comprised between approximately 60 and approximately 90 g/m2 and a thickness of between 70 and 120 microns are preferably used, consisting of hard (HW) or soft (SW) wood fibres with lengths typically comprised between 0.5 and 5 mm.

The resins that can be used can belong to three main families: urea-formaldehyde resin, melamine-formaldehyde resin and polyamidoamine-epichlorohydrin resin. Other solutions may be vinyl-based glues such as for example polyvinyl acetate. Further alternatives are polyethylenimine, dialdehyde starch, polyacrylamides with glyoxal substituents (GPAM), alkyl ketene dimers (AKD) and alkenyl succinic anhydride (ASA).

Polyamide epichlorohydrin (also known as PAE) is a cationic resin belonging to the polyamidoamine-epichlorohydrin resin family; several types are commercially available, e.g. under the brand name Kimene®.

Said resins are part of paper sticks that have been previously treated with water, which is necessary to ensure that the rolled paper remains closed and does not unroll. Water can be added in several steps. In one process, most of the rolling can be dry, while only the final part of the rolling involves the addition of drops of water. In an alternative process, the water is added before the sheet of paper is rolled up, therefore the entire rolling operation takes place with wet paper. Resin can be added at the same time as the water in the form of a water emulsion as is the case with PAE or vinyl acetate emulsions. The drying phase is necessary in order to evaporate excess moisture and to help the resin harden and bond to the paper fibrils (cross-linking), also through covalent bonds as is the case when using PAE.

Waxes as lubricating substances must necessarily be present on the external surface of the stick, their purpose being to promote the sliding of the sticks between each other, during the steps of loading machines for making lollipops, and also on the metal or other material parts of the machines themselves.

The waxes that can be used in the process of the invention can be of any compatible type, in particular carnauba wax, beeswax, polyolefin waxes. They are applied by conventional methods. The waxes may be present in mixtures with each other or carried by more complex preparations containing for example oils and/or additives.

The heat treatment of the sticks can be carried out before or after the application of the wax. If it takes place before, heating takes place during the manufacture of the paper sticks. A drying treatment is already in place in the manufacture of paper sticks with the aim of eliminating part of the water brought by the previous production steps (usually with the resin). In the process of the invention, however, the temperature is increased >60° C. preferably to >90° C. and even more preferably around 100° C. The drying temperature is preferably <180° C., higher temperatures damage the paper by yellowing it. The sticks are dried in an efficient system, such as a drying tunnel or spiral conveyor, where the sticks are exposed to heat and/or to forced air in a very efficient manner. When the air temperature is regulated as described, it takes 1 to 30 minutes, preferably 5 to 15 minutes, to heat and dry them and accelerate the curing of the resin. In continuous production, the hot sticks are fed into a waxing device for surface treatment. Since the sticks are hot, the wax dissolves and penetrates more into the cellulose matrix, leaving part of the cellulose exposed on the surface, thus leading to better grip. This phenomenon results. in the process of the invention, in a greater quantity of polar cellulose on the surface compared to a non-inventive process, thus increasing the overall polarity of the surface of the paper stick. This increase is demonstrated by the fact that the measured contact angles in water are smaller in the sticks of the invention with respect to the contact angles of the sticks made according to the prior art (Example 8). Thus the sticks can be collected and stored for future use.

In the case of heat treatment after waxing, the manufacture of the paper stick is conventional. Before being introduced into the line of production of confectionery products (lollipops), the waxed paper sticks can be introduced into a hot environment from 15 minutes up to 72 hours, temperatures are >40° C., preferably 70° C. to 150° C. Particularly advantageous conditions are temperature >45° C. and times >36 h. In this case the sticks are exposed for longer times because there is less air flow and less efficient heat conduction. The final effect is in any case the same, the wax that is applied onto the surface of the sticks penetrates inside the cellulose matrix, exposing part of the cellulose fibres on the surface, thus determining the desired features. After heating, the sticks are sent to the lollipops production line.

To characterise the effect of the heat, confocal Raman microscopy was used on conventional sticks and treated according to the invention. Confocal Raman microscopy (CRM) can characterise and map the distribution of different chemical compounds in a sample. This technique makes it possible to localise different compounds on the surface of an object (mapping a certain area) or in its interior (in the body) for a few tens of micrometres (in this case via a line).

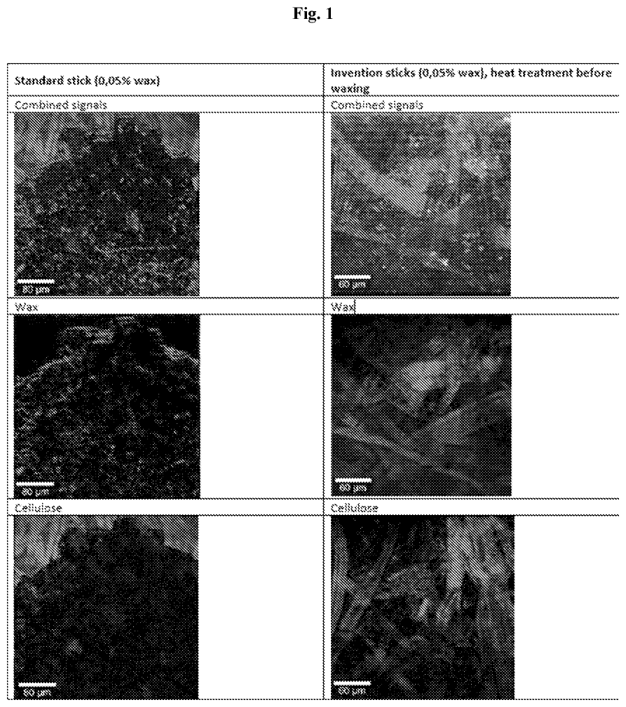

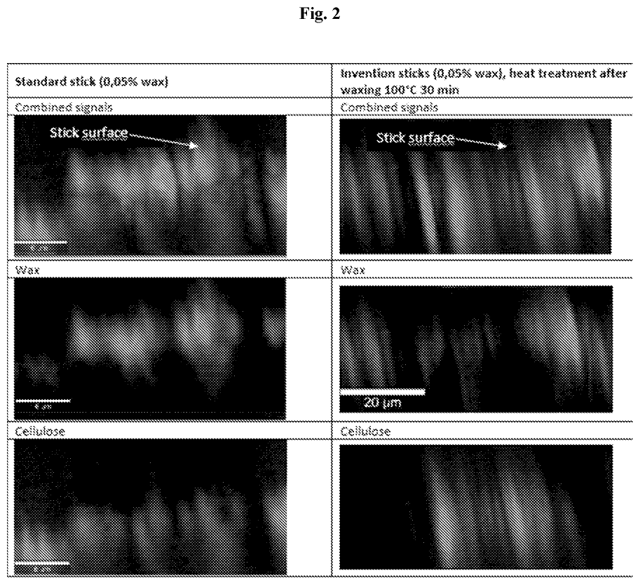

In the images obtained in surface mapping mode, the sticks of the invention show cellulose fibres evenly distributed over the surface, whereas conventional sticks have less cellulose exposed superficially and only on some small areas of the surface (FIG. 1). The sticks of the invention show how the wax and cellulose are at the same depth with respect to the surface thanks to the heat treatment described previously, which allows the wax to penetrate the cellulose matrix, whereas in conventional sticks the wax is localised on the surface, above the cellulosic material (FIG. 2).

The sticks of the invention exhibit an acceptable or optimal detachment force once inserted in the lollipop. The detachment force is measured by means of a vertical dynamometer in traction mode with a 500 N load cell and within 6 minutes of exiting the cooling tunnel, following the insertion of the stick, while the central volume of the edible material of the lollipop is still warm, i.e. above room temperature.

More particularly lollipops are characterised by a detachment force of the sticks of the invention from the edible part ≥90N (acceptable), preferably ≥150N (optimal) when measured within 6 minutes of exiting the cooling tunnel after insertion of the stick in the edible part of the lollipop.

More particularly, the sticks of the invention, characterised by roughness >4.1 μm measured as previously described or characterised by contact angle measured by the dynamic Wilhelmy method between 600 and 820 and having a moisture content no higher than 6%, have an acceptable detachment force once inserted in the lollipop, i.e. a force >90N.

When the sticks of the invention are characterised by a contact angle measured by the dynamic Wilhelmy method of between 68° and 790 and having a moisture content of between 3.5% and 5.5%, they exhibit an optimal detachment force once inserted in the lollipop, i.e. a force >150N.

### EXAMPLES

### Example 1: Making a Paper Stick According to the Prior Art

A sheet of paper, with the properties shown in Table 1, is processed in the process according to the prior art, cutting a paper roll on the basis of the length of the stick, applying an emulsion of water and PAE resin, rolling up the paper and drying the excess water in a spiral dryer at a temperature of <50° C., then applying a layer of wax according to prior arts, resulting in a stick described in Table 2 with regard to some macroscopic parameters.

TABLE 1
Properties of the paper

| Basis Weight (g/m²) | Thickness (μm) | Type of fibres |
|---|---|---|
| 88 | 123 | Mixture of HW and SW fibres |

TABLE 2
Properties of the stick

| | Length | Diameter | Weight per | Quantity of |
|---|---|---|---|---|
| Shape | (mm) | (mm) | single piece (g) | wax (w/w) |
| Cylindrical | 80 | 3.9 | 0.77-0.80 | 0.05% |

### Example 2: Making a Paper Stick According to the Invention

A paper stick is made as described in Example 1, with the exception of the drying temperature brought to 98° C. for more than 1 minute. The features of the paper are those shown in Table 1 and the macroscopic features of the stick are shown in Table 2.

### Example 3: Instrumental Characterisation of the Sticks of Examples 1 (Prior Art) and 2 (Invention)—Surface Roughness

The sticks of Examples 1 and 2 are characterised by determination of residual moisture at 105° C. for 3 h according to the standard ASTM D644-99. The initial bending stiffness according to ISO 5628—UNI 10184. Roughness is determined with an FRT MicroProf® instrument over a length of 42 mm, taking 12000 values. The roughness is then reported as standard deviation in μm of the maxima and minima on an average scale (0.06-2 mm).

TABLE 3
Properties of the sticks

| | Residual moisture | Initial bending | |
|---|---|---|---|
| Example | (%) | stiffness (N*m) | Roughness (μm) |
| Example 1 - | 6.1 | 9.1 | 3.8-4.1 |
| prior art | | | |
| Example 2 - | 5.5 | 9.8 | 4.3-5 |
| invention | | | |

The sticks of Example 2 according to the invention are less moist, stiffer and rougher than the sticks of Example 1 according to the prior art.

### Example 4: Making the Edible Material of the Lollipop

According to the prior art, water, sugar and glucose syrup are brought to the boil, obtaining a concentrated solution of sugars and carbohydrates. A quantity of a mixture of milk derivatives is added to this solution. The final solution is cooked under vacuum to a moisture content of <4%, resulting in a molten mass. Strawberry flavouring, strawberry juice concentrate and citric acid are added to this mass, according to known quantities, obtaining a final molten mass of hard candy at a temperature >100° C., yet to be formed.

### Example 5: Making Lollipops According to the Prior Art

In a continuous process, the mass from Example 4 is cooled and reduced into single pieces according to prior arts. At the same time or immediately after obtaining the single pieces of edible material, the sticks of Example 1 are inserted using high-speed machinery. The lollipops are immediately introduced into a cooling tunnel. Lollipops are then obtained according to the prior art and described in Table 4. The overall efficiency of the process is rated in quality terms as insufficient, sufficient or good by three technical experts. In this specific case, the efficiency is rated as ‘good’.

### Example 6: Making Lollipops According to the Invention

What is reported in Example 5 is repeated, however the sticks from Example 2 are used. Lollipops are therefore obtained, according to the invention, as described in Table 4. The overall efficiency of the process is assessed in quality terms as insufficient, sufficient or good by three technical experts. In this specific case, the efficiency is rated as ‘good’.

The efficiency of the process is therefore not reduced by the use of sticks according to the invention compared to the use of sticks according to the prior art.

TABLE 4
Macroscopic properties of the lollipops

| | | Penetration | Weight | Shape | |
|---|---|---|---|---|---|
| | | of stick in | of | of | |
| | Type of | the edible | edible | edible | Diameter |
| Example | stick | part (mm) | part (g) | part | (mm) |
| Example 5 - | Example 1 - | 17 | 12 | Spher- | 27 |
| prior art | prior art | | | oidal | |
| Example 6 - | Example 2 - | 17 | 12 | Spher- | 27 |
| invention | invention | | | oidal | |

### Example 7: Measurement of the Detachment Force of the Sticks with Heat

Ten (10) lollipop pieces according to Example 5 are taken at the exit of the cooling tunnel and analysed within 6 minutes using a vertical dynamometer with a 500 N load cell. The stick is attached to the upper jaw, while the edible part is inserted into a lower housing to secure it. The dynamometer is operated in extension, recording the force required to detach the edible part or break the stick. The detachment values, expressed as mean, minimum, average, maximum and standard deviation of the ten values are given in Table 5.

The procedure is repeated several times in an identical manner, taking 10 lollipop pieces according to Example 6, making several samplings. The detachment values, expressed as mean, minimum, average, maximum and standard deviation of the ten values are given in Table 5.

TABLE 5
Detachment force of the sticks according to
the invention and according to the prior art

| | Examples | | |
|---|---|---|---|
| | Example 6 | Example 6 | Example 5 |
| | (invention) | (invention) | (prior art) |
| Samplings | 1 | 2 | 1 |
| Minimum (N) | 101 | 108 | 37 |
| Average (N) | 150 | 153 | 49 |
| Maximum (N) | 213 | 205 | 62 |
| Standard Deviation(N) | 37.5 | 28.6 | 9.2 |

The lollipops of Example 6 all have values above the threshold of 90N, while the lollipops of Example 5 have minimum, average and maximum values below this threshold.

### Example 8: Instrumental Characterisation of the Sticks of Examples 1 (Prior Art) and 2 (Invention)—Contact Angle

The sticks of Examples 1 and 2 are characterised by determination of the contact angle according to the following procedure, carried out with a Kruss K100SF tensiometer.

The instrument is loaded with Milli-Q® water.

It is checked that the tension of the water is 72 mN/m.

15 sticks to be tested are cut to the length of 40-50 mm.

One stick at a time is loaded onto the instrument.

$$Immersion speed = 15 mm / min .$$

$$Immersion depth = 20 mm .$$

$$Total readings per stick per immersion = 100 over 20 mm .$$

The stick is immersed a first time

The contact angle is acquired on entry in the water at the first immersion, taking the average and standard deviation of all 1500 readings.

This is followed by extraction and second immersion.

The contact angle is acquired on entry in the water at the second immersion, taking the average and standard deviation of all 1500 readings.

This is followed by extraction, drop absorption at the tip and removal of the stick from the instrument.

The water absorbed is determined by weight difference between the stick before immersion and after the second immersion.

TABLE 6
Contact angle and water absorption

| Parameter | Example 1 | Example 2 |
|---|---|---|
| Contact angle first immersion - average (degrees) | 85 | 80 |
| Contact angle first immersion - standard deviation | 4.6 | 3 |
| (degrees) | | |
| Contact angle second immersion - average | 21 | 4 |
| (degrees) | | |
| Contact angle second immersion - standard | 14 | 13 |
| deviation (degrees) | | |
| Average water absorption per stick (g) | 0.035 | 0.040 |
| Average water absorption per stick (%) | 9.4 | 10.75 |

### Example 9—Correlation of Contact Angle with Detachment Force

Sticks according to Example 1 (prior art) and 2 (invention) are made in several consecutive batches, slightly varying the drying temperature. The batches are identified as 1-1; 1-2, 2-1, 2-2, 2-3, 2-4 where the first number refers to the example number and the second number is the progressive batch number. The sticks are subjected to contact angle measurement as per Example 8 and used in the manufacture of lollipops as described in Examples 4, 5, 6 while also assessing the efficiency of the process. The detachment force is measured for each batch as in Example 7 and evaluated as “acceptable” if >90N and “not acceptable” if <90N, optimal if >150N.

| | | Moisture | | Efficiency | Contact angle |
|---|---|---|---|---|---|
| | Invention/ | content | Detachment | of the | 1st immersion - |
| Batch | Prior Art | (%) | force | process | average value |
| 2-1 | Invention | 3.43 | Acceptable | Insuffi- | 81.6 |
| | | | | cient | |
| 2-2 | Invention | 4.41 | Optimal | Insuffi- | 74.5 |
| | | | | cient | |
| 2-3 | Invention | 5.04 | Optimal | Good | 79.0 |
| 2-4 | Invention | 5.47 | Optimal | Good | 73.1 |
| 1-1 | Prior Art | 6.09 | Not | Good | 82.9 |
| | | | Acceptable | | |
| 1-2 | Prior Art | 7.7 | Not | Good | 85.6 |
| | | | Acceptable | | |
| 2302- | Invention | 5.1 | Optimal | Good | 78.9 |
| 2023 | | | | | |
| 2309- | Invention | 5.1 | Optimal | Good | 78.1 |
| 2023 | | | | | |
| M | | | | | |
| 2309- | Invention | 5.1 | Optimal | Good | 72.3 |
| 2023 | | | | | |
| A | | | | | |
| 2296- | Invention | 4.3 | Optimal | Good | 78.8 |
| 2023 | | | | | |
| 2325- | Invention | 4.4 | Optimal | Good | 73.1 |
| 2023 | | | | | |

1. Paper and resin sticks on which at least one wax as lubricant is applied, characterised by a roughness >4.1 μm, measured by confocal microscopy techniques with chromatic aberration or characterized by a contact angle measured with the dynamic method according to Wilhelmy between 60° and 82° and having a humidity content not higher than 6%.

2. Paper and resin stick according to claim 1 wherein the roughness is between 4.3 μm and 5 μm.

3. Paper and resins stick according to claim 1 wherein the resin is epichlorohydrin polyamide.

4. (canceled)

5. Paper and resin stick according to claim 1 wherein the waxes are selected from polyolefin waxes.

6. Paper and resin stick according to claim 1 characterised by a contact angle between 82° and 73°, measured by means of a water immersion technique on first immersion.

7. Paper and resin stick according to claim 6 characterized by a contact angle <20°, measured by means of a water immersion technique at the second immersion.

8. Paper and resin stick according to claim 7 characterized by water absorption >10.7% by weight, measured by difference by weight in water after two immersions.

9. A process for the preparation of paper and resin sticks comprising the application of a wax a lubricating substance to the pre-formed paper and resin sticks and a drying treatment, wherein said treatment can take place before or after the application of the wax, obtaining in both cases cellulose fibres uniformly distributed on the surface of the stick.

10. A process for preparing of paper and resin sticks according to claim 9 in which the drying treatment is carried out at temperatures >60° C., but not higher than 180° C. for times between 1 and 30 minutes to a moisture content of not more than 6% by weight of the stick and is carried out before the application of wax.

11. A process for preparing paper and resin sticks according to claim 9 wherein the drying treatment is carried out at temperatures >40° C., for times between 15 minutes and 72 hours, to a moisture content not exceeding 6% by weight of the stick and is carried out after application of the wax.

12. Use of the paper and resin sticks of claim 1 in a lollipop production plant.

13. Use of the paper and resin sticks according to claim 12 such that said lollipops are characterized a detachment force of the sticks from the edible part >90N when measured within 6 minutes after the exit of the cooling tunnel following the insertion of the stick into the edible part of the lollipop.
